(19) United States
(12) Patent Application Publication
(10) Pub. No.: US 2004/0163922 A1
(43) Pub. Date: Aug. 26, 2004

(54) Actuating device, in particular for a vehicle clutch

(75) Inventor: Barbara Ester, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/785,469

(22) Filed: Feb. 24, 2004

(30) Foreign Application Priority Data
Feb. 25, 2003 (DE) 103 07 864.9

(51) Int. Cl. B60T 13/00

(52) U.S. Cl. 192/85 CA

(57) ABSTRACT

An actuating device, in particular for a vehicle clutch, comprising a cylinder, in which a piston executes, as a function of a supply of pressure medium, a working movement having a maximum working travel which is defined by a stop fixed in relation to the cylinder, a damping device being arranged between the stop and a working-travel limiting surface of the piston.

### BACKGROUND OF THE INVENTION

1. Field of the Invention

The invention relates to an actuating device, in particular for a vehicle clutch, including a cylinder, a stop which is fixed in relation to the cylinder, and a piston which can execute a working movement in the cylinder as a function of a supply of pressure medium, the piston having a maximum working travel defined by the stop.

2. Description of the Related Art

U.S. Pat. No. 6,116,399 discloses an actuating device, in particular for a vehicle clutch, comprising a cylinder, in which a piston executes, as a function of a supply of pressure medium, a working movement having a maximum working travel which is defined by a stop fixed in relation to the cylinder. For example, FIG. 5 shows a stop 197d which is arranged fixedly in relation to the cylinder and is formed by a securing ring known per se.

In the event of incorrect control or maladjustment in the supply of pressure medium, it cannot be ruled out entirely that the piston is pressed onto the stop with great force. Although the stop is sufficiently dimensioned, the load is nevertheless very high per se. In this case, two different influences detrimental to the stop function arise. On the one hand, the stop force must be taken into account, which, for example, could be controlled by means of even greater dimensioning of the stop. Furthermore, depending on the construction of the actuating device, a relative rotational movement may occur between the piston and the cylinder of the actuating device, during which the securing ring is lifted out of its annular groove.

### SUMMARY OF THE INVENTION

The object of the present invention is to design an operationally reliable stop for the piston movement within an actuating device.

According to the invention, the object is achieved in that a damping device is arranged between the stop and a working-travel limiting surface of the piston.

With the damping device being used, the stop is subjected to load in a much more careful way and markedly increased operating strength can be achieved. Furthermore, possible stop noises are reduced.

In the simplest instance, the damping device is formed by an elastic body. The elastic body may be an elastomer, a spring or else a spring set.

In a further development of the invention in structural terms, the piston is mounted on a guide sleeve and is centered by at least one guide ring, the guide ring forming the damping device. The guide ring consequently assumes the centering and limit-damping functions, the extra outlay, as compared with a version, such as is known from the prior art, being relatively minor.

Alternatively or in combination, the piston is sealed off in relation to a wall of the cylinder by means of at least one seal, the seal forming the damping device. A common element for the centering, sealing and limit-damping functions could be achieved by means of an appropriate choice of material.

Furthermore, there may be provision for the piston to have an annular step which on one side comprises the working-travel limiting surface in the direction of a stop surface of the stop, and a cylindrical surface which is oriented in the direction of the circumferential surface of the stop. This prevents the situation where, in the stop position of the piston, a stop formed by a slotted ring may be lifted out of its annular groove during a circumferential movement of the piston in relation to the cylinder. The cylindrical surface of the step on the piston effectively prevents a radial widening of the stop.

According to a further advantageous embodiment, the cylindrical surface of the piston and the circumferential surface of the stop are designed conically. A braking action, the action of which is dependent on the piston position with respect to the stop, is generated.

An elastomeric ring may be arranged on the piston between the circumferential surface of the stop and the cylindrical surface of the annular step. The response behavior of the stop is consequently modified. Furthermore, a compression space, which has a damping action, is obtained.

The stop may be formed by a radially elastic ring which is mounted with radial play in a groove. When the piston moves onto the stop, not only is a groove side wall subjected to load, but the groove bottom is also subjected to the load of the radial force component. Consequently, the load is distributed from the stop to the component fixed in relation to the cylinder, over a larger area, that is to say, overall, is reduced.

In a further variant, the stop and the piston form a compression space which is volume-dependent as a function of the piston position. The compression space filled with air acts in the same way as a mechanical spring.

For this purpose, the stop may form a part of the compression space into which the piston can move.

For an increase in operating level, a seal, which seals off the compression space, is introduced functionally between the cylindrical surface of the piston and the stop.

In addition, there may be provision for the compression space to be designed with at least one throttle orifice. The throttle orifice generates a damping force.

The compression space may have a plurality of throttle orifices which are blocked in relation to the cylinder as a function of the position of the piston. A stroke-dependent increase in the damping action is thereby achieved.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIGS. 1-9 show a damping device with an elastic body;

FIGS. 10-15 show a damping device with a radially elastic ring;

FIGS. 16-19 show a damping device with a compression space.

### DETAILED DESCRIPTION OF THE PRESENTLY PREFERRED EMBODIMENTS

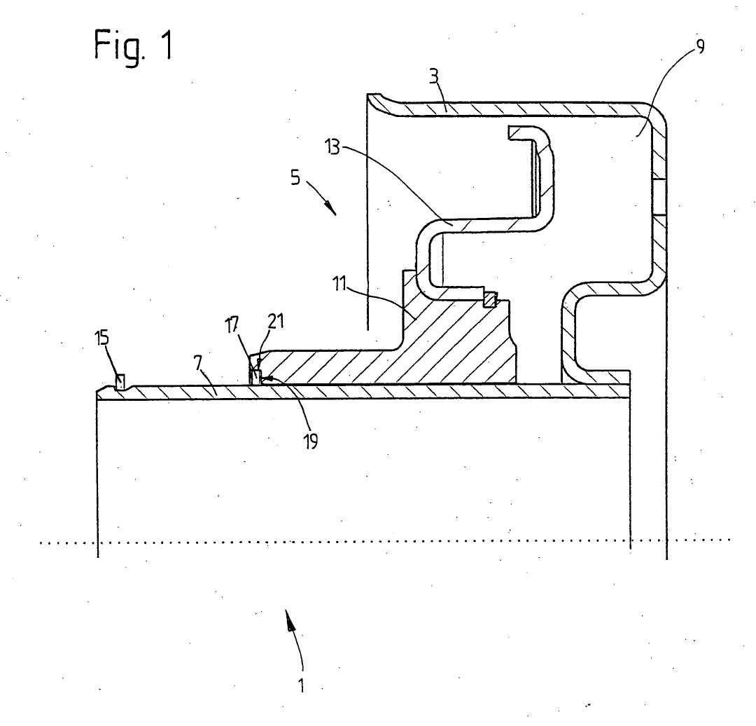

FIG. 1 shows the essential parts of an actuating device 1 comprising a cylinder 3 in which a piston 5 is mounted axially displaceably. The cylinder and a guide sleeve 7 define, together with the piston, a pressure space 9 which may be filled arbitrarily via a pressure supply, not illustrated, with the result that the piston executes the axial movement on the guide sleeve. The guide sleeve constitutes, in practice, a part of the cylinder.

In this exemplary embodiment, the piston consists of a hub 11 and of a piston sleeve 13. The internal construction of the piston is not relevant to the invention.

A component, that is to say the cylinder itself or the guide sleeve, which is fixed in relation to the cylinder 3, carries a stop 15 which defines an end position of the piston. The piston itself displaces a connection to a vehicle clutch, not illustrated, which is in this case transferred into an open or a closed operating state.

The piston has an annular step 17 which on one side has a working-travel limiting surface 19 and a cylindrical surface 21. The working-travel limiting surface is oriented in the direction of the stop 15 and, in the end position of the piston, comes into contact with the stop. The cylindrical surface of the piston or of the hub in this case prevents a radial widening of the stop in the event of maximum load on the stop. The stop could also be provided, for example, on the inner wall of the cylinder, and the step on the piston sleeve 13.

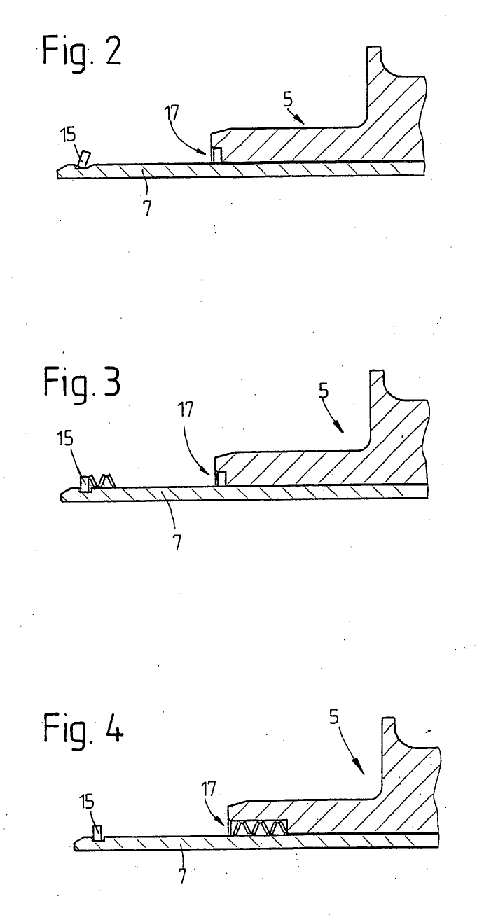

With a view to a gentle impingement of the piston on the stop, a damping device is used. In the simplest instance, the stop 15 is formed by a resilient body 23, such as is illustrated, for example, in FIG. 2 by an inclined securing ring. In FIGS. 3 and 4, additional resilient bodies in the form of construction of a cup spring or else corrugated springs are used. By means of a layered arrangement, a controlled force characteristic of the damping device can be achieved. In FIG. 3, the resilient bodies are held, centered, on the guide sleeve and so as to be assigned to the stop, whereas, in FIG. 4, they are held so as to be assigned to the piston and on the cylindrical surface 21 of the annular step 17.

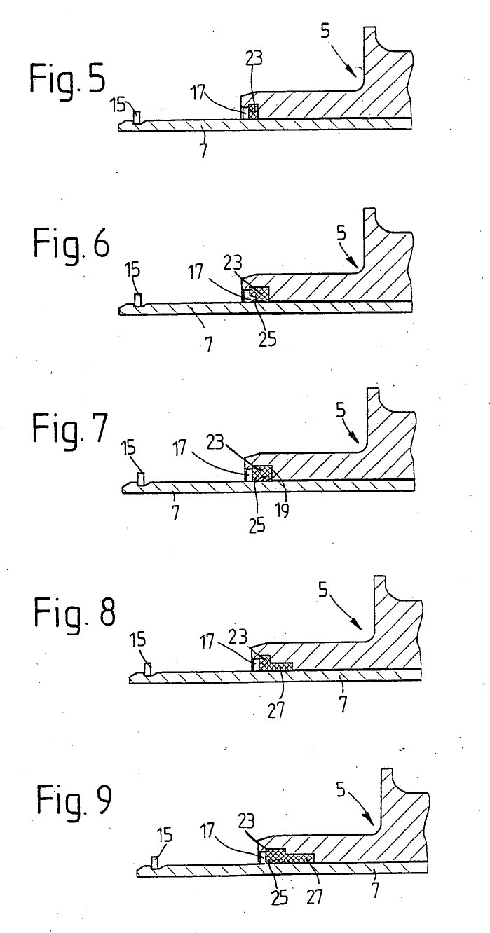

In FIGS. 6 to 9, the resilient body is formed by an elastomer which is arranged fixedly on the piston 5. In the simplest instance according to FIG. 5, an elastomeric ring is clamped into the annular step 17 of the piston. As soon as the elastomer impinges onto the stop 15, the elastomer is prestressed radially inward onto the guide sleeve 7, since a radial widening of the annular step 17 on the piston is prevented. A travel-dependent friction brake is thereby achieved.

In FIG. 6, the elastomer 23 is also supplemented by a seal 25, in which case a decision must be made, in the individual case, as to whether the seal 25 extends directly in the direction of the stop 15 or in the direction of the working-travel limiting surface 17 of the annular step 17, as shown in FIG. 7.

Alternatively, the resilient body 23 may also assume the function of a guide ring 27, as illustrated in FIG. 8. FIG. 9 is intended to illustrate that a combination of all the functional possibilities illustrated in FIGS. 5 to 8 may also be envisaged, so that the resilient body additionally assumes a sealing function and a guide function.

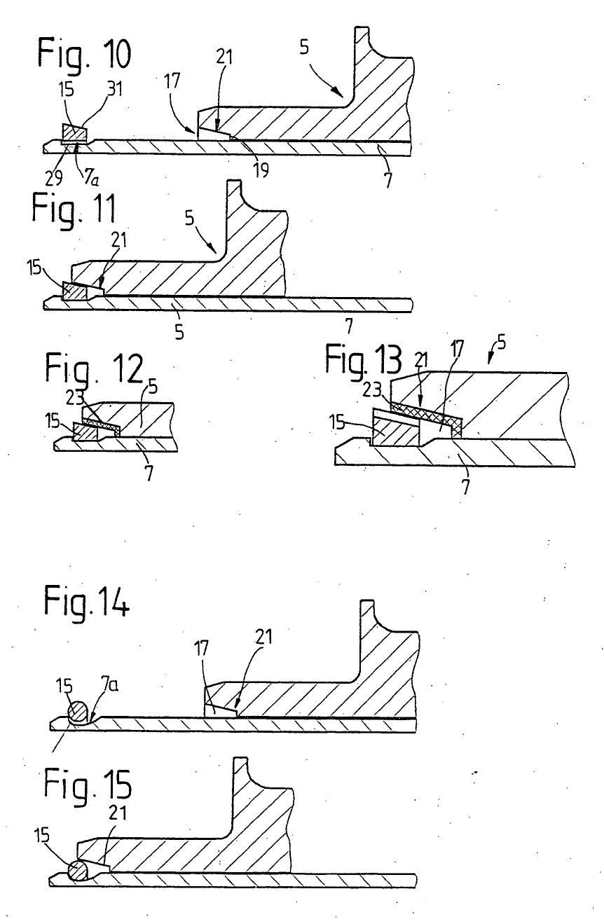

In contrast to FIGS. 1 to 9, in FIGS. 10-15 the circumferential surfaces 21 of the annular step 17 on the piston 5 are designed as conical surfaces. A travel-dependent radial prestress is consequently exerted on the stop 15. The annular stop 15 is mounted with radial play 29 within a groove 7a. At least in FIGS. 10 and 11, the stop is provided with a slot, not illustrated, so that the stop is elastically deformable radially within limits. As soon as the hub 5 comes into axial overlap with the stop, the conical surface 21 acts on a circumferential surface 31 of the stop, which is also designed as a conical surface. In the maximum end position, see FIG. 11, the radial play 29 between the stop and the guide sleeve 7 is canceled.

In FIGS. 12 and 13, the resilient body is arranged in the form of an elastomeric ring 23 between the cylindrical surface 21 of the annular step on the piston and the circumferential surface 31 of the stop 16. The annular step 17 forms a compression space into which the stop can move axially. The elastomeric ring acts in the same way as a seal, thus producing a damping device which can be adapted in its mode of action to the requirements by means of a throttle orifice. The exemplary embodiments according to FIGS. 12 and 13 do not necessarily have to have a slotted ring as a stop 15. Alternatively, a closed ring 15 in conjunction with a securing ring may also be used.

The version according to FIGS. 14 and 15 corresponds in its mode of action to the principle according to FIGS. 10 and 11. Instead of a conically shaped circumferential surface, a stop with a circular cross section is used, the stop 15 again having a slotted design.

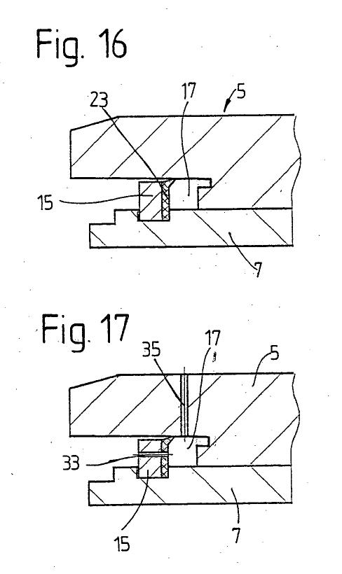

FIGS. 16 to 19 in each case disclose stops 15 which, together with the piston, form the compression space. Contrary to FIG. 13, in FIG. 16, the stop 15 is assigned the elastomeric body 23 which assumes a sealing function for the annular step 17, serving as compression space, of the piston 5.

As shown in FIG. 17, a speed-dependent action of the damping device can be achieved by means of a throttle orifice 33. Using a plurality of throttle orifices 33; 35, this speed-dependent action can also be determined as a function of the instantaneous piston position, in that, for example shortly before the end position of the piston 5 is reached, the throttle orifice lies outside the compression space and only the throttle cross section of the throttle orifice 33 is effective.

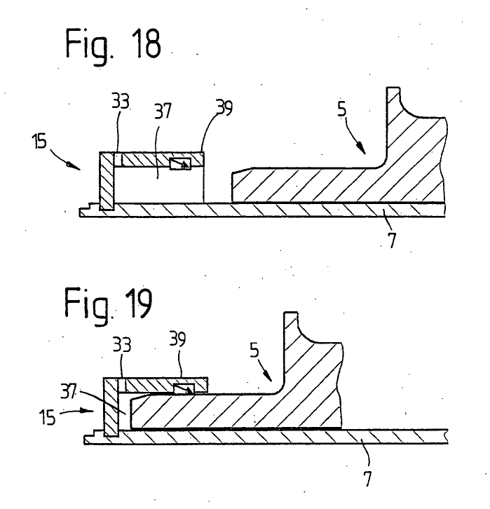

FIGS. 18 and 19 are intended to illustrate that the stop 15, too, may form a part of the compression space 37 into which the piston 5 can move. A seal 41 is introduced between the piston and a sleeve portion 39 of the stop 15. Once again, one or, if appropriate, even a plurality of throttle orifices 33 may be used.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An actuating device for a vehicle clutch, said actuating device comprising:
a cylinder;
a stop which is fixed in relation to the cylinder;
a piston which can execute a working movement in said cylinder as a function of a supply of pressure medium, said piston having a working travel limiting surface; and
a damping device arranged between the stop and the working travel limiting surface.

2. An actuating device as in claim 1 wherein the damping device comprises a resilient body.

3. An actuating device as in claim 2 further comprising a guide sleeve on which said piston is mounted for movement and a guide ring which centers said piston on said guide sleeve, said guide ring forming said damping device.

4. An actuating device as in claim 2 further comprising a guide sleeve on which said piston is mounted for movement and a seal which seals said piston in relation to said guide sleeve, said seal forming said damping device.

5. An actuating device as in claim 1 wherein the piston has an annular step comprising an axial surface which forms said working travel limiting surface and a circumferential surface which is oriented toward a circumferential surface of the stop.

6. An actuating device as in claim 1 wherein the stop and the piston form a compression space having a volume which is dependent on the position of the piston.

7. An actuating device as in claim 6 wherein the stop forms a part of the compression space into which the piston can move.

8. An actuating device as in claim 5 wherein said annular step forms part of a compression space having a volume which is dependent on the position of the piston, the actuating device further comprising a seal which is effective between the circumferential surface of the piston and the circumferential surface of the stop.

9. An actuating device as in claim 6 further comprising a throttle orifice communicating with said compression space.

10. An actuating device as in claim 9 comprising a plurality of throttle orifices communicating with said compression space, said orifices being blocked as a function of the position of the piston.

11. An actuating device as in claim 5 wherein said circumferential surfaces are conical surfaces.

12. An actuating device as in claim 11 further comprising an elastomeric ring between the conical surface of the piston and the conical surface of the stop.

13. An actuating device as in claim 1 further comprising a groove in which the stop is mounted, the stop comprising a radially elastic ring which is mounted in the groove with radial play.
